(19) United States
(12) Patent Application Publication
(10) Pub. No.: US 2012/0009494 A1
(43) Pub. Date: Jan. 12, 2012

(54) SYSTEM OF A PLURALITY OF SERIES-CONNECTED CONVERTER DEVICES FOR A FUEL CELL APPARATUS AND METHOD FOR CONTROLLING THE SYSTEM

(75) Inventors: Chen-Kun Chou, Taoyuan (TW); Chi-Bin Wu, Taoyuan (TW)

(73) Assignee: Chung-Hsin Electric and Machinery Manufacturing Corp., Jhonghe City (TW)

(21) Appl. No.: 12/881,194

(22) Filed: Sep. 14, 2010

(30) Foreign Application Priority Data
Jul. 6, 2010 (TW) 099122237

(51) Int. Cl. H01M 8/04

(52) U.S. Cl. 429/430; 429/428

(57) ABSTRACT

A system of a plurality of series-connected converter devices for a fuel cell apparatus and a method for controlling the system are provided. The system includes a fuel cell apparatus controller, the plurality of converter devices, a series connection unit, a Mux control unit, a power control unit, and a master controller. The output ends of the plurality of converter devices are connected in series by the series connection unit. The master controller reads signals from the power control unit and the Mux control unit and determines accordingly which converter devices need to be turned on to meet the requirement of a load. The method includes the steps of estimating a load, determining the number of the converter devices to be turned on, calculating an output power, discharging, and charging. Thus, the plurality of converter devices is controlled to output the required power of the load.

### BACKGROUND OF THE INVENTION

1. Technical Field

The present invention relates to a system of a plurality of series-connected converter devices for a fuel cell apparatus and a method for controlling the system. More particularly, the present invention relates to a system and a method for charging and discharging via the plurality of series-connected converter devices.

2. Description of Related Art

Electricity, which has been indispensable to the daily lives of humans since the Industrial Revolution, is generated nowadays mainly by thermal or nuclear power. However, as both of these power generation methods have adverse impacts on the environment, and given the increasing abnormalities in today's global climate, it is imperative to generate electricity by alternative means.

Fuel cells generate electricity through chemical reactions which do not produce substances harmful to the environment, and therefore fuel cells have been an important developing trend of power generation technology. For instance, a conventional fuel cell-based power generation system typically includes three major parts: a fuel cell stack for generating electricity, a converter for converting the unstable electricity generated by the fuel cell stack into a stable power source for output, and a battery for providing electricity in conjunction with the fuel cell stack in which the fuel cell stack alone is insufficient to cope with an increase in the load, wherein the battery stops supplying electricity as soon as the power generated by the fuel cell stack meets the load requirement.

The aforesaid conventional fuel cell-based power generation system is disadvantageous in that the electricity generated by the fuel cell stack will not be output when the converter is damaged, which is extremely inconvenient. Moreover, a desired increase in the output power of the fuel cell stack is not achieved until the chemical reactions of the fuel cell stack are completed. Therefore, if the load increases abruptly and goes beyond the capacity of the battery, a shortage of power supply is bound to occur, and the load will be affected as a result.

In addition, when fuel is added to the fuel cell stack, the chemical reactions of the added fuel will upset the stability of the output power temporarily, which is likely to damage the load.

### BRIEF SUMMARY OF THE INVENTION

It is an object of the present invention to provide a system of a plurality of series-connected converter devices for a fuel cell apparatus and a method for controlling the system, wherein in order to meet load voltage requirements or effectively increase power output, a single high-power fuel cell apparatus is connected in parallel to the input ends of the plurality of converter devices while the output ends of the converter devices are connected in series. Thus, different requirements in load output can be satisfied without using extra converter modules designed for different voltages.

It is another object of the present invention to provide a system of a plurality of series-connected converter devices for a fuel cell apparatus and a method for controlling the system, wherein the system and the method can prevent the supply of electricity from being interrupted should one of the converter devices be damaged, and wherein the system and the method can also prevent unstable power supply which may otherwise occur during fuel refill. In addition, with a single high-power fuel cell apparatus, the converter devices become capable of charging and discharging and are modularized with their output ends connected in series so as to work in high-power applications.

To achieve the foregoing objects, the present invention provides a system of a plurality of series-connected converter devices for a fuel cell apparatus, wherein the system includes: a fuel cell apparatus controller which is electrically connected to the fuel cell apparatus; the plurality of converter devices which is electrically connected to an output end of the fuel cell apparatus and an output end of the fuel cell apparatus controller and which are configured for converting the electricity generated by the fuel cell apparatus and outputting the converted electricity; a series connection unit which is electrically connected to each converter device and configured for delivering electrical energy to a load; a Mux control unit which is electrically connected to the series connection unit and configured for reading the amount of electricity output by the series connection unit; a power control unit which is electrically connected to the load and configured for calculating the amount of electricity required by the load; and a master controller which is electrically connected to the Mux control unit, the power control unit, and each converter device.

The present invention also provides a method for controlling the foregoing system of a plurality of series-connected converter devices for the fuel cell apparatus, wherein the method includes: a step of estimating a load, wherein a load power value and a load output voltage value required by the load are calculated; a step of determining the number of the converter devices to be turned on, wherein the number of the converter devices that need to be turned on is determined according to the load power value or the load output voltage value, and the converter devices selected are defined as the working converter devices; a step of calculating an output power, wherein a required output power of each working converter device is assigned to and to be provided by each working converter device is calculated; a step of discharging, wherein when the available output power of the fuel cell apparatus is above 0 but lower than the required output power, the battery of each working converter device works in conjunction with the fuel cell apparatus to provide the required output power, and when the available output power of the fuel cell apparatus is 0, the battery of each working converter device provides the required output power; and a step of charging, wherein when the amount of electricity of the battery of each working converter device is smaller than a predetermined amount and the available output power of the fuel cell apparatus is higher than the required output power, the fuel cell apparatus begins to charge the corresponding battery.

Implementation of the present invention at least involves the following inventive steps:

1. Even if one of the converter devices is damaged, power supply will not be interrupted.

2. Unstable power supply associated with the addition of fuel is prevented.

3. The converter devices to be turned on are selected according to load requirements so as to meet the required load voltage or increase the output power, thereby saving the manpower and costs for designing additional converter devices.

4. With the elements in the fuel cell-based power generation system being modularized, and the output ends of the converter devices being connected in series, the present invention is suitable for use in high-power applications.

A detailed description of the features and advantages of the present invention is given below so that a person skilled in the art is enabled to gain insight into the technical contents disclosed herein and implement the present invention accordingly. A person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

FIG. 1 is a schematic drawing of a system of a plurality of series-connected converter devices for a fuel cell apparatus according to an embodiment of the present invention; and

FIG. 2 is a flowchart of a method according to another embodiment of the present invention for controlling the system of FIG. 1.

### DETAILED DESCRIPTION OF THE INVENTION

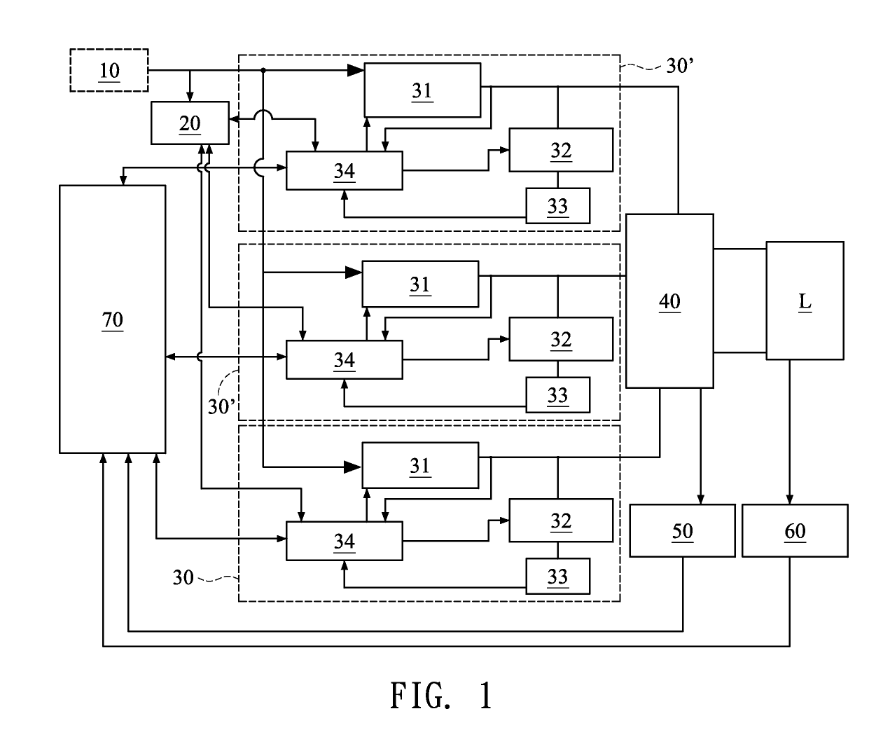

Referring to FIG. 1, in an embodiment of the present invention, a system of a plurality of series-connected converter devices for a fuel cell apparatus includes: a fuel cell apparatus controller 20, a plurality of converter devices 30, a series connection unit 40, a Mux control unit 50, a power control unit 60, and a master controller 70.

The fuel cell apparatus controller 20 is electrically connected to a fuel cell apparatus 10, wherein the fuel cell apparatus 10 generates electricity by chemical reactions. The fuel cell apparatus controller 20 is electrically connected to the output end of the fuel cell apparatus 10 and is configured to calculate the amount of energy to be distributed to each converter device 30 according to the number and output power of the converter devices 30 parallel-connected to the output end of the fuel cell apparatus 10.

The plurality of converter devices 30 is electrically connected to the output end of the fuel cell apparatus 10 and the output end of the fuel cell apparatus controller 20 and are configured to convert the electricity generated by the fuel cell apparatus 10 and then output the converted electricity.

The series connection unit 40 is electrically connected to each converter device 30 and the output ends of the plurality of converter devices 30 in series so as to output the received electrical energy to a load L and thereby supply electricity to the load L.

The Mux control unit 50 is electrically connected to the series connection unit 40 and is configured to read the amount of electricity output by the series connection unit 40.

The power control unit 60 is electrically connected to the load L and is configured to calculate the amount of electricity required by the load L.

The master controller 70 is electrically connected to the Mux control unit 50, the power control unit 60, and each converter device 30. The master controller 70 is configured to read signals from the Mux control unit 50 and the power control unit 60, calculate the signals read, and after judgment, transmit a control signal to each converter device 30.

Each converter device 30 includes a converter 31, a bi-directional converter 32, a battery 33, and a sub-controller 34.

Each converter 31, which is electrically connected to the output end of the fuel cell apparatus 10, is configured to convert the electrical energy output by the fuel cell apparatus 10 and then output the converted electrical energy to the series connection unit 40.

Each bi-directional converter 32 is electrically connected to the output end of the corresponding converter 31 and is configured to output the electricity of the corresponding battery 33 to the series connection unit 40. Each battery 33 is electrically connected to the corresponding bi-directional converter 32, and is discharged when the output voltage of the fuel cell apparatus 10 is insufficient. More specifically, to discharge a certain battery 33, the corresponding bi-directional converter 32 allows the electrical energy of the battery 33 to pass through and flow to the series connection unit 40, thereby compensating for the insufficiency of electrical energy.

Each sub-controller 34 is electrically connected to the corresponding converter 31, the corresponding battery 33, and the fuel cell apparatus controller 20 so as to monitor the electrical energy output by the corresponding converter 31 and the amount of electricity stored in the corresponding battery 33. Each sub-controller 34 is controlled by the master controller 70 and in turn controls the operation of the corresponding converter 31 and bi-directional converter 32.

The master controller 70 determines which converter devices 30 should be turned on based on signals from the Mux control unit 50 or the power control unit 60, and then transmits a control signal to each sub-controller 34. Thus, control by the master controller 70 is achieved.

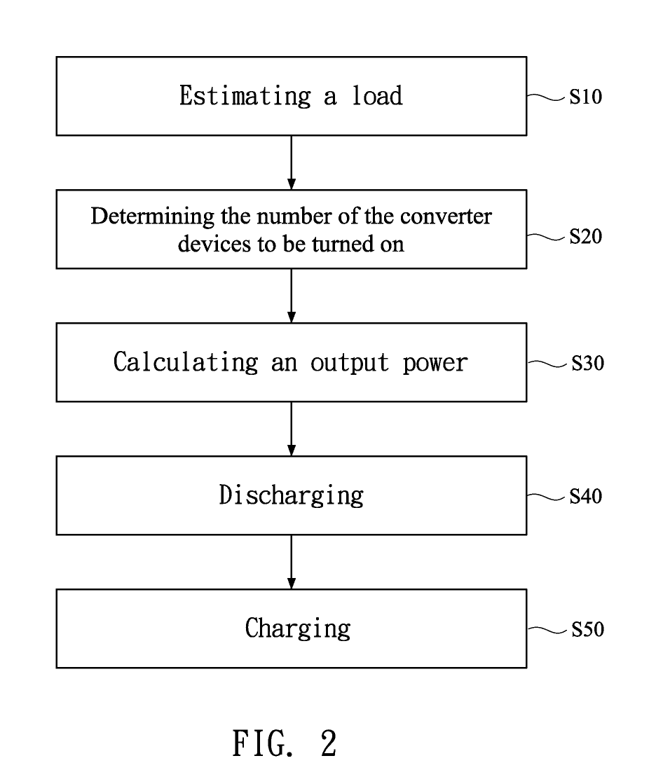

In another embodiment of the present invention as shown in FIG. 2, a method for controlling the foregoing system of the plurality of series-connected converter devices 30 for the fuel cell apparatus 10 includes: a step of estimating a load (S10), a step of determining the number of the converter devices to be turned on (S20), a step of calculating an output power (S30), a step of discharging (S40), and a step of charging (S50), as described in detail below.

The step of estimating a load (S10): The power control unit 60 calculates or reads a load power value and a load output voltage value that are required by the load L.

The step of determining the number of the converter devices to be turned on (S20): Based on the load power value or the load output voltage value, the master controller 70 determines the number of the converter devices 30 that need to be turned on. The converter devices 30 thus selected are defined as the working converter devices 30′.

More specifically, to determine the number of the working converter devices 30′, either the load power value required by the load L is divided by the maximum output power of each converter device 30, or the load output voltage value required by the load L is divided by the maximum output voltage of each converter device 30. The master controller 70 controls the converter devices 30 that need to be turned on. The converter devices 30 actually turned on are defined as the working converter devices 30′. The output ends of the working converter devices 30′ are connected in series by the series connection unit 40 so as to output electrical energy.

The step of calculating an output power (S30): The master controller 70 calculates a required output power that is assigned to and to be provided by each working converter device 30′. More specifically, the required output power of each working converter device 30′ is calculated by dividing the load power value by the number of the working converter devices 30′.

The step of discharging (S40): When the available output power of the fuel cell apparatus 10 is above 0 but lower than the required output power, the bi-directional converter 32 in each working converter device 30′ is turned on to allow the electrical energy of the corresponding battery 33 to pass through. Thus, the electrical energy of the battery 33 of each working converter device 30′ is combined with the output of the fuel cell apparatus 10 to provide the required output power. However, when the available output power of the fuel cell apparatus 10 is 0, it is the battery 33 of each working converter device 30′ that provides the required output power. Each bi-directional converter 32 is controlled by the corresponding sub-controller 34 with regard to whether or not to discharge the corresponding battery 33.

The step of charging (S50): When the amount of electricity of the certain battery 33 of each working converter device 30′ is smaller than a predetermined amount, and the available output power of the fuel cell apparatus 10 is higher than the required output power (meaning that the fuel cell apparatus 10 not only can provide the electricity required by the load L but also has extra electricity to be stored in the batteries 33), the sub-controller 34 corresponding to that particular battery 33 turns on the corresponding bi-directional converter 32 to charge the battery 33 for later use. Each bi-directional converter 32 is controlled by the corresponding sub-controller 34 with regard to whether or not to charge the corresponding battery 33.

With the present invention, power supply will not be interrupted if any one of the converter devices 30 is damaged; furthermore, unstable power supply which may otherwise occur during fuel refill is prevented. The present invention also features modularization and hence expandability. Besides, in cases where the load L increases abruptly such that the output power of the working converter devices 30′ is insufficient to meet the requirement of the load L, the batteries 33 are discharged to maintain power supply stability.

The embodiments described above serve to demonstrate the features of the present invention so that a person skilled in the art can understand the contents disclosed herein and implement the present invention accordingly. The embodiments, however, are not intended to limit the scope of the present invention. Therefore, all equivalent changes or modifications which do not depart from the spirit of the present invention should fall within the scope of the present invention, which is defined only by the appended claims.

What is claimed is:

1. A system of a plurality of series-connected converter devices for a fuel cell apparatus, the system comprising:
a fuel cell apparatus controller electrically connected to the fuel cell apparatus;
the plurality of converter devices electrically connected to an output end of the fuel cell apparatus and an output end of the fuel cell apparatus controller and configured to convert electricity generated by the fuel cell apparatus and output the converted electricity;
a series connection unit electrically connected to each said converter device and configured to deliver electrical energy to a load;
a Mux control unit electrically connected to the series connection unit and configured to read an amount of electricity output by the series connection unit;
a power control unit electrically connected to the load and configured to calculate an amount of electricity required by the load; and
a master controller electrically connected to the Mux control unit, the power control unit, and each said converter device.

2. The system of claim 1, wherein each said converter device comprises:
a converter electrically connected to the output end of the fuel cell apparatus;
a bi-directional converter electrically connected to the converter;
a battery electrically connected to the bi-directional converter; and
a sub-controller electrically connected to the converter, the battery, and the fuel cell apparatus controller and controlled by the master controller so as to control operation of the converter and the bi-directional converter.

3. The system of claim 2, wherein the master controller determines which of the converter devices need to be turned on, based on signals from the Mux control unit and the power control unit, and transmits a control signal to each said sub-controller.

4. A method for controlling the system of claim 1, comprising:
a step of estimating a load, wherein a load power value and a load output voltage value required by the load are calculated;
a step of determining the number of said converter devices to be turned on, wherein the number of said converter devices that need to be turned on is determined according to the load power value or the load output voltage value, and the converter devices selected are defined as working converter devices;
a step of calculating an output power, wherein a required output power assigned to and to be provided by each said working converter device is calculated;
a step of discharging, wherein when the fuel cell apparatus has an available output power above 0 but lower than the required output power, a battery in each said working converter device works in conjunction with the fuel cell apparatus to provide the required output power, and when the available output power of the fuel cell apparatus is 0, the battery of each said working converter device provides the required output power; and
a step of charging, wherein when an amount of electricity of a said battery is smaller than a predetermined amount, and the available output power of the fuel cell apparatus is higher than the required output power, the fuel cell apparatus begins to charge the corresponding battery.

5. The method of claim 4, wherein the step of determining the number of said converter devices to be turned on comprises either dividing the load power value by a maximum output power, or dividing the load output voltage value by a maximum output voltage of each said converter device, so as to determine the number of said converter devices to be selected.

6. The method of claim 5, wherein the step of calculating an output power comprises dividing the load power value by the number of the working converter devices so as to obtain the required output power to be provided by each said working converter device.

7. The method of claim 6, wherein the working converter devices are connected in series by the series connection unit.

8. The method of claim 7, wherein the step of estimating a load comprises calculating, by the power control unit, the load power value and the load output voltage value required by the load.

9. The method of claim 8, wherein the step of determining the number of said converter devices to be turned on comprises controlling, by the master controller and according to the load power value or the load output voltage value, the working converter devices to be turned on.

10. The method of claim 9, wherein the step of calculating an output power comprises calculating, by the master controller, the required output power assigned to and to be provided by each said working converter device.

11. The method of claim 10, wherein the step of discharging comprises controlling a bi-directional converter of each said working converter device by a corresponding sub-controller so as to control discharging of the corresponding battery.

12. The method of claim 11, wherein the step of charging comprises controlling the bi-directional converters by the corresponding sub-controllers so as to control charging of the corresponding batteries.
